(19) United States
(12) Patent Application Publication
(10) Pub. No.: US 2008/0168773 A1
(43) Pub. Date: Jul. 17, 2008

(54) DEVICE FOR INJECTING A MIXTURE OF AIR AND FUEL, AND COMBUSTION CHAMBER AND TURBOMACHINE WHICH ARE PROVIDED WITH SUCH A DEVICE

(75) Inventor: Denis Jean Maurice SANDELIS, Nangis (FR)

Correspondence Address: OBLON, SPIVAK, MCCLELLAND MAIER & NEUSTADT, P.C., 1940 DUKE STREET, ALEXANDRIA, VA, 22314, US

(73) Assignee: SNECMA, Paris (FR)

(21) Appl. No.: 11/941,551

(22) Filed: Nov. 16, 2007

(30) Foreign Application Priority Data
Nov. 16, 2006 (FR) 0610012

(51) Int. Cl. F02C 1/00

(52) U.S. Cl. 60/748

(57) ABSTRACT

The invention relates to the field of turbomachines and concerns a device for injecting a mixture of air and fuel into a combustion chamber of a turbomachine. It more specifically concerns a novel injection device (100), provided with an additional venturi (120), which makes it possible to improve the level of emissions and the relight capacity of the combustion chamber while at the same time preventing any flashback.

### BACKGROUND OF THE INVENTION AN DESCRIPTION OF THE PRIOR ART

The invention relates to the field of turbomachines and concerns a device for injecting a mixture of air and fuel into a combustion chamber of a turbomachine.

It more specifically concerns a novel injection device which makes it possible to improve the level of emissions and the relight capacity of the combustion chamber while at the same time preventing any flashback.

Throughout the remainder of the description, the terms “upstream” or “downstream” will be used to denote the positions of the structural elements with respect to one another in the axial direction, taking the gas flow direction as reference. Likewise the terms “internal” or “radially internal” and “external” or “radially external” will be used to denote the positions of the structural elements with respect to one another in the radial direction, taking the axis of rotation of the turbomachine as reference.

A turbomachine comprises one or more compressors delivering pressurized air to a combustion chamber in which the air is mixed with fuel and ignited so as to generate hot combustion gases. These gases flow in the downstream direction of the chamber toward one or more turbines which convert the energy thus received in order to rotate the compressor or compressors and provide the work required, for example, to power an aircraft.

Typically, a combustion chamber used in aeronautics comprises an internal wall and an external wall interconnected at their upstream end by a chamber endwall. The chamber endwall has, spaced circumferentially, a plurality of openings each accommodating an injection device which allows the mixture of air and fuel to be fed into the chamber. Each injection device particularly comprises a fuel injector, radial swirlers, a venturi, a bowl and a deflector, all joined together, the chamber endwall being fastened to the deflector.

The combustion chamber is supplied with liquid fuel, mixed with air from a compressor. The liquid fuel is fed as far as the chamber by the injectors in which it is vaporized into fine droplets. This vaporization is initiated at the injector by means of nozzles and is continued at the venturi and the bowl under the effect of the pressurized air coming from a compressor. This pressurized air passes, on the one hand, through the radial swirlers of the injection device so as to cause the fuel atomized by the injector to rotate, and, on the other hand, through orifices formed in various parts of the injection device, such as the bowl.

As illustrated in document FR 2 753 779, atomization is achieved in a first instance by pressurized air passing through one or more corotating radial swirlers. It is then continued downstream by pressurized air passing through orifices formed in the bowl and shearing the layer of fuel produced at the radial swirlers.

Unfortunately, this injection device architecture is not optimal for all engines. In particular, in certain cases it may, on the one hand, be the cause of higher gas emissions in idle mode and, on the other hand, diminish the relight capacity of the engine in certain operating conditions on the ground and in flight.

### SUMMARY OF THE INVENTION

The objective of the invention is to provide a novel injection device architecture which makes it possible to reduce the gas emissions in idle mode and to improve the relight capacities of the engine on the ground or in flight while ensuring that there is no possibility of any flashback toward the upstream region, for example into the radial swirlers, and while keeping unchanged a maximum number of parts of the injection device according to the prior art.

The invention makes it possible to solve these problems by providing an injection device which includes an addition venturi arranged inside the bowl and associated with specific holes in the walls of the bowl.

More particularly, the invention concerns a device for injecting a mixture of air and fuel into a combustion chamber of a turbomachine, the injection device having a symmetry of revolution about an axis Y and including, arranged from upstream to downstream in the gas flow direction, a sliding bushing connected by an annular cup to one or more radial or axial swirlers, the swirlers being provided with a first venturi and injecting pressurized air inside the injection device at an axial velocity V1 while at the same time causing it to rotate about the axis Y, a bowl spaced axially from the radial swirlers, the bowl including an upstream end, a cylindrical wall extended by a flared wall, and a downstream end. This injection device is noteworthy in that it includes a second venturi arranged inside the bowl coaxially to the axis Y, the second venturi comprising an upstream end, a cylindrical part extended by a divergent part, and a downstream end, the cylindrical part of the second venturi being concentric with the cylindrical wall of the bowl, the upstream end of the second venturi being arranged axially at the same level as the upstream end of the bowl, and in that the flared wall of the bowl is provided with two rows of orifices which are distributed circumferentially in a regular fashion and whose axes belong to a plane orthogonal to the flared wall of the bowl and have a tangential inclination in the opposite direction to the direction of rotation of the air injected by the swirlers, these rows of orifices injecting pressurized air at an axial velocity V2, the injected pressurized air being contrarotating with respect to the air injected by the swirlers.

The total length of the second venturi and that of the bowl are preferably such that the total length of the second venturi represents between 80 and 100% of that of the bowl.

Preferably, the largest diameter of the cylindrical part of the second venturi represents between 70 and 80% of the largest diameter of the flared wall of the bowl.

Advantageously, the first row of orifices in the flared wall of the bowl injects a quantity of pressurized air corresponding to 10 to 20% of the pressurized air injected by the two rows of orifices, and the second row of orifices in the flared wall of the bowl injects a quantity of pressurized air corresponding to 80 to 90% of the pressurized air injected by the two rows of orifices.

Finally, the ratio V2/V1 is advantageously between 2 and 3.

Moreover, the invention also concerns a combustion chamber comprising an internal wall, an external wall and a chamber end wall and provided with at least one such injection device.

The invention finally concerns a turbomachine provided with such a combustion chamber.

### BRIEF DESCRIPTION OF THE DRAWINGS

The invention will be better understood and other advantages thereof will become more clearly apparent in the light of the description of a preferred embodiment which is given by way of nonlimiting example and with reference to the appended drawings, in which:

FIG. 1 is a schematic sectional view of a turbomachine, more specifically an aircraft jet engine;

FIG. 2 is a schematic sectional view of the upstream part of a combustion chamber provided with an injection device according to the prior art;

FIG. 3 is a detailed schematic sectional view of an injection device according to the prior art;

FIG. 4 is a schematic sectional view of an injection device according to the invention;

FIG. 5 is a schematic sectional view of an injection device according to a variant of the invention.

### DESCRIPTION OF THE PREFERRED EMBODIMENTS

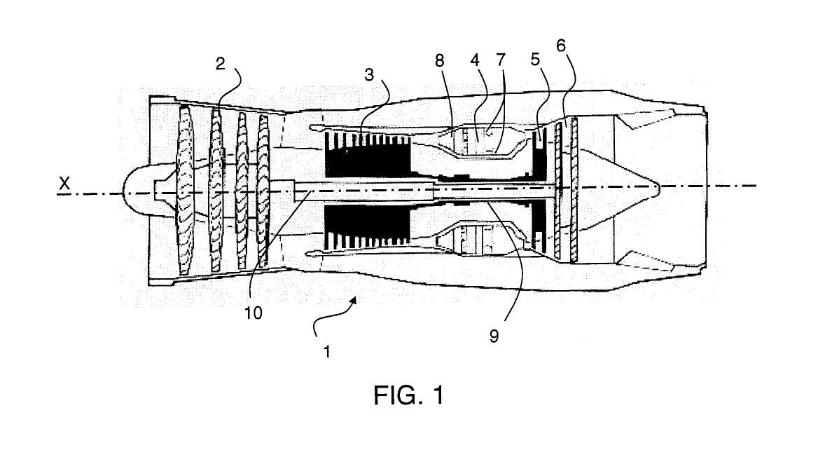

FIG. 1 shows in section an overall view of a turbomachine 1, for example an aircraft jet engine, comprising a low-pressure compressor 2, a high-pressure compressor 3, a combustion chamber 4, a low-pressure turbine 5 and a high-pressure turbine 6. The combustion chamber 4 may be of the annular type and is defined by two annular walls 7 spaced radially with respect to the axis X of rotation of the jet engine, these walls being connected at their upstream end to an annular chamber endwall 8. The chamber endwall 8 has a plurality of openings (not shown) with a regular circumferential spacing. In each of these openings is mounted an injection device. The combustion gases flow downstream in the combustion chamber 4 and then supply the turbines 5 and 6 which respectively drive the compressors 2 and 3, arranged upstream of the chamber endwall 8, by way of two respective shafts 9 and 10. The high-pressure compressor 3 supplies air to the injection devices and also to two annular spaces respectively arranged radially to the inside and outside of the combustion chamber 4. The air introduced into the combustion chamber 4 assists in atomizing the fuel and in its combustion. The air circulating outside the walls of the combustion chamber 2 assists in cooling these walls and enters the chamber through dilution holes (not shown) in order to cool the combustion gases transmitted to the turbine.

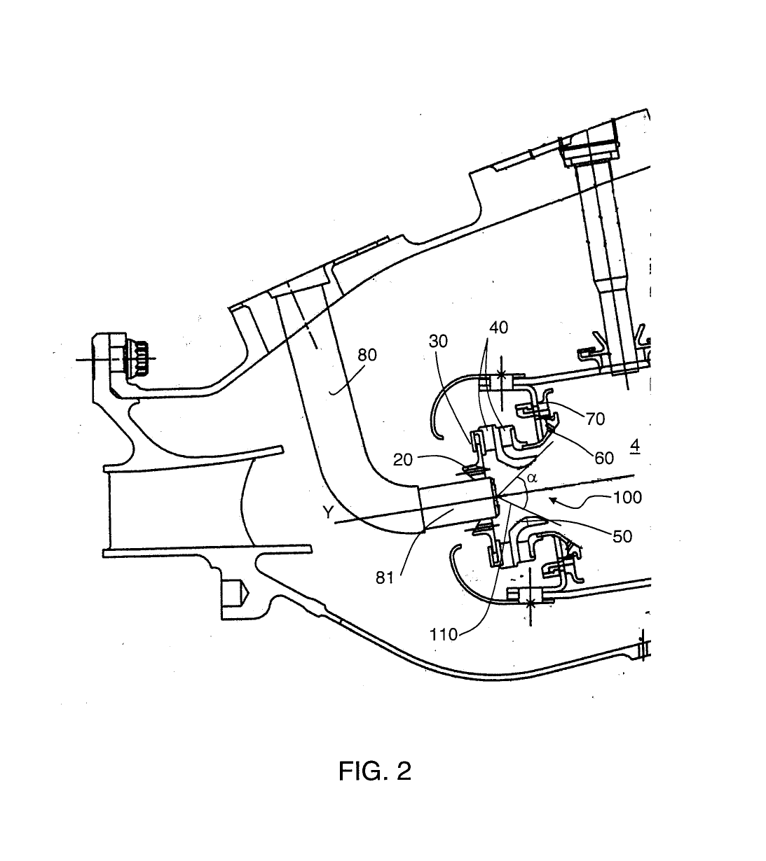

FIG. 2 shows in section an exemplary embodiment of an injection device 100 according to the prior art. The injection device 100, whose axis of symmetry of revolution is referenced Y, includes, arranged from upstream to downstream, an injector 80 arranged at the center of a sliding bushing 20 connected by an annular cup 30 to radial swirlers 40. The radial swirlers 40 include a venturi 50 and are connected by their downstream end to a bowl 60 having a divergent conical wall. The bowl 60 is itself connected to the chamber endwall 8 via a deflector 70.

The combustion chamber 4 is supplied with liquid fuel, mixed with air from a compressor. The liquid fuel is fed as far as the chamber by the injectors 80. The downstream end 81, also termed the head, of the injectors 80 is positioned within the injection device 100, at the center of the sliding bushing 20, so that the axis of symmetry of the head 81 of the injectors corresponds to the axis of symmetry of the sliding bushing. Each injector head 81 includes a nozzle (not shown) which is responsible for the carburetion of the air-fuel mixture, this mixture leaving the injectors in the form of a cone 110 of vertex angle α.

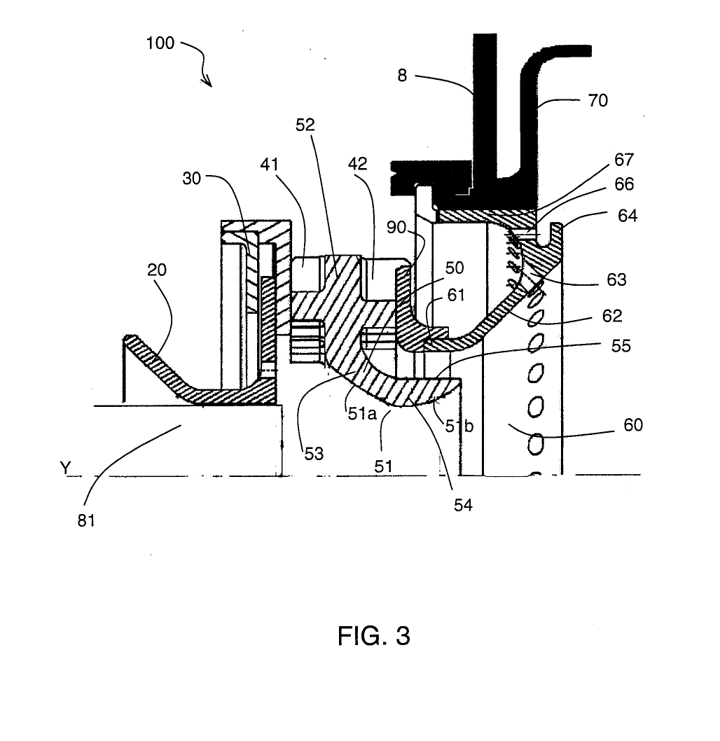

FIG. 3 shows a detailed schematic sectional view of an injection device according to the prior art.

The venturi 50, arranged between two radial swirlers 41 and 42, has an inner wall 51 with a variable profile composed of a convergent part 51a and of a divergent part 51b which are joined together by a transition region, the venturi having a minimum diameter at the transition region. It is composed of a radially extending annular part 52 connected by its radially internal end to a convergent conical part 53 which is extended downstream by a divergent part 54. The annular part 52 connects the venturi 50 upstream to the radial swirler 41 and downstream to the radial swirler 42. The divergent part 54 includes an outer surface 55 and an inner surface. The outer surface 55 is a cylinder of axis Y, while the inner surface flares out and constitutes the divergent part 51b of the inner wall 51 of the venturi.

In the example illustrated here, the second radial swirler 42 is connected, downstream, to the bowl 60 via a connection piece 90. It is equally well possible for this connection to be made directly between the radial swirler 42 and the bowl 60 without any intermediate piece. The bowl 60 includes a cylindrical wall 61 extended by a flared wall 62 in the downstream direction. The cylindrical wall 61 of the bowl is arranged coaxially to the axis Y and surrounds the divergent part 54 of the venturi 50, thus channeling the pressurized air injected at the second radial swirler 42. The flared wall 62 of the bowl includes a plurality of air-introducing holes 63 supplied by air coming from the high-pressure compressor 3. Said wall is additionally provided, at its downstream end, with an annular flange 64 extending radially outward. The bowl 60 also includes a cylindrical support wall 65, coaxial to the axis Y, connecting the bowl to the deflector 70. The cylindrical support wall 65 is connected to the downstream end of the flared wall 62 just upstream of the annular flange 64 and is arranged radially toward the outside of the bowl. Cooling holes 66 are formed in the region of the connection between the cylindrical support wall 65 and the flared wall 62. The job of these cooling holes 66 is to convey air from the high-pressure compressor 3 in order to cool the annular flange 64.

The deflector 70 for its part is arranged in the combustion chamber parallel to the chamber endwall 8.

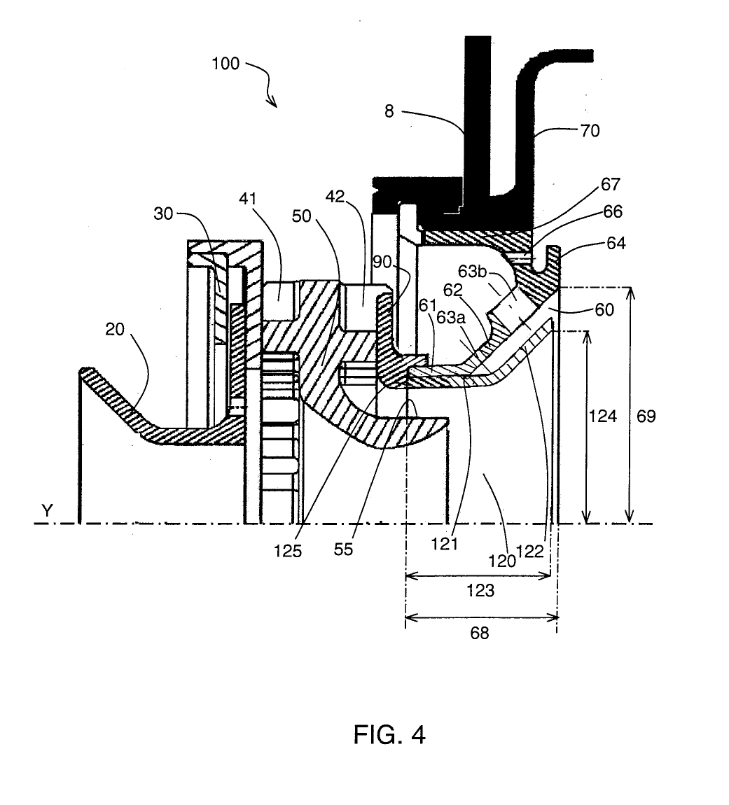

FIG. 4 shows a detailed schematic sectional view of an injection device 100 according to the invention.

This injection device 100, of axis Y, includes, arranged from upstream to downstream, a sliding bushing 20 connected to one or more corotating radial swirlers 41, 42 via an annular cup 30. The radial swirlers include a first venturi 50 and are connected, downstream, to a bowl 60 by means of a connection piece 90. This connection piece is not indispensable and could, for example, be in one piece with the bowl or the radial swirlers. The bowl is itself fastened at the center of a deflector 70 which is positioned on a chamber endwall 8, parallel thereto.

According to the invention, the injection device 100 includes a second venturi 120 arranged inside the bowl 60, coaxially to the axis Y. The second venturi 120, the total length of which is referenced 123, includes a cylindrical part 121 which is concentric with the cylindrical wall 61 of the bowl and extended downstream by a divergent part 122 whose largest diameter is referenced 124. The upstream end 125 of the second venturi 120 is arranged axially at the same level as the upstream end of the bowl. The cylindrical part 121 of the second venturi, which can be brazed to the cylindrical wall 61 of the bowl, is dimensioned such that there is no unevenness shape in the region of connection with the connection piece 90 in order not to disturb the flow of pressurized air from the second radial swirler 42.

Preferably, the dimensions of the second venturi 120 are such that its total length 123 represents 80 to 100% of the total length of the bowl, referenced 68, the length of the cylindrical part 121 of the second venturi remaining greater than the length of the cylindrical wall 61 of the bowl. Moreover, the largest radius 124 of the second venturi 120 advantageously represents between 70 and 80% of the largest radius of the bowl, referenced 69.

According to the invention, additional arrangements are formed on the flared wall 62 of the bowl 60. Specifically, this flared wall is provided with two rows of orifices 63a and 63b distributed circumferentially in a regular fashion. The first row of orifices 63a, also termed purge orifices, is formed in the vicinity of the connection between the cylindrical wall 61 and the flared wall 62 of the bowl. The second row of orifices 63b is formed downstream of the first row of orifices 63a without projecting axially beyond the second venturi 120. The axes of the orifices of each of these two rows are orthogonal to the flared wall 62 of the bowl and have a tangential inclination in the opposite direction to the tangential inclination of the radial swirlers 41 and 42. Thus, the pressurized air injected at the rows of orifices 63a and 63b is caused to rotate about the axis Y in a contrarotating manner with respect to the pressurized air injected at the radial swirlers 41 and 42. The diameters of the orifices are dimensioned such that the air injected at the first row of orifices 63a represents 10 to 20% of the permeability of the bowl and such that the air injected at the second row of orifices 63b represents 80 to 90% thereof. By permeability of the bowl is meant the throughput of air which is injected there so as to create the desired mixture of air and fuel.

The air injected at the first row of orifices 63a makes it possible to facilitate the tangential swirling of the air at the second row of orifices 63b. It additionally makes it possible to prevent any possible backflow of fuel, and hence any flashback, at the flared wall 61 of the bowl. Owing to the impact of this air on the second venturi 120, the latter is cooled, the temperature of its walls is made uniform and the risk of coking is thus reduced or even becomes zero.

By virtue of the invention, the air-fuel premix resulting from the mixing performed at the radial swirlers 41, 42 leaves the second venturi 120 with an axial velocity V1 and is sheared by the air emanating from the bowl at an axial velocity V2, this air swirling contrarotationally with respect to the swirling of the premix emanating from the radial swirlers. The invention thus makes it possible to achieve ratios V2/V1 of around 2 to 3 and, immediately downstream of the bowl 60, creates a recirculation zone in which a vortex is formed. As it leaves the bowl, the air-fuel mixture has an improved atomization quality and also an increased axial velocity. Moreover, the vortex thus formed makes it possible to prevent any flashback inside the injection device and hence prevents this device from being thermally damaged. The vortex additionally makes it possible to improve the stability and the relight capacity of the chamber by promoting flame propagation and distribution. It also makes it possible to increase the residence time of the air-fuel mixture in the chamber and thus to improve the efficiency in idle mode and to reduce the gas emissions. Another advantage of the invention is that it makes it possible to retain a large proportion of the components making up the injection device.

Specifically, comparing FIGS. 3 and 4 for example, it can be seen that only the bowl 60 has been modified, thus making it possible to guarantee interchangeability with the existing injection devices.

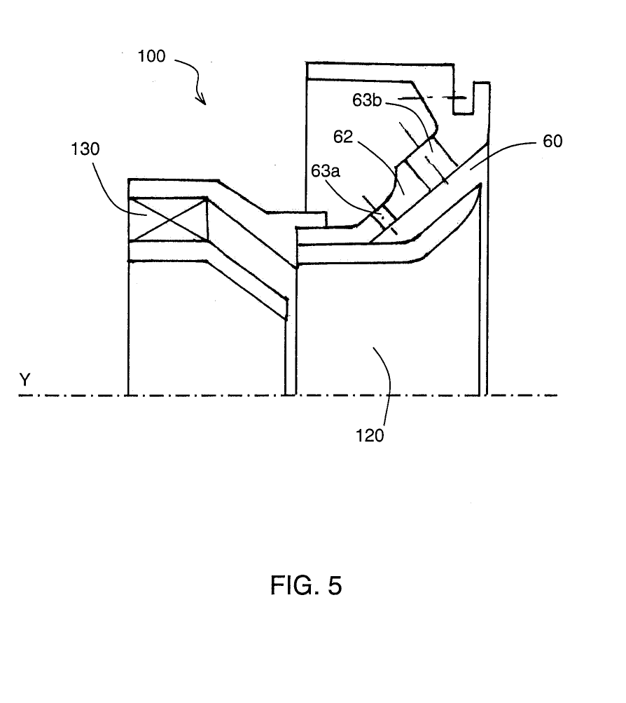

In the exemplary embodiment illustrated in FIG. 4, the bowl 60 is provided with two rows of circular orifices 63a and 63b and the second row of orifices 63b is made through a boss formed radially to the outside of the bowl 60. The description and the aforementioned advantages associated with the invention remain valid whatever the geometry of the orifices (circular or oblong holes; slots, etc.). Likewise, the second row of orifices 63b can be made equally well through a boss or directly through the flared wall 62 of the bowl, without any excess thickness. Finally, as illustrated in FIG. 5, the technology forming the subject of the invention can be applied similarly to an injection device which is supplied, not by one or more radial swirlers, but by one or more axial swirlers. In the example shown in FIG. 5, the injection device 100, represented in part, particularly includes an axial swirler 130 which performs the same function as the second radial swirler 42 shown in FIG. 4 and which is connected downstream to an assembly according to the invention formed by a bowl 60 connected to a second venturi 120, the bowl being provided on its flared wall 62 with two rows of orifices 63a and 63b according to the invention.

1. A device for injecting a mixture of air and fuel into a combustion chamber of a turbomachine, the injection device having a symmetry of revolution about an axis Y and including, arranged from upstream to downstream in the gas flow direction, a sliding bushing connected by an annular cup to one or more radial or axial swirlers, the swirlers being provided with a first venturi and injecting pressurized air inside the injection device at an axial velocity V1 while at the same time causing it to rotate about the axis Y, a bowl spaced axially from the radial swirlers, the bowl including an upstream end, a cylindrical wall extended by a flared wall, and a downstream end, wherein the injection device includes a second venturi arranged inside the bowl coaxially to the axis Y, the second venturi comprising an upstream end, a cylindrical part extended by a divergent part, and a downstream end, the cylindrical part of the second venturi being concentric with the cylindrical wall of the bowl, the upstream end of the second venturi being arranged axially at the same level as the upstream end of the bowl, and wherein the flared wall of the bowl is provided with two rows of orifices which are distributed circumferentially in a regular fashion and whose axes belong to a plane orthogonal to the flared wall of the bowl and have a tangential inclination in the opposite direction to the direction of rotation of the air injected by the swirlers, these rows of orifices injecting pressurized air at an axial velocity V2, the injected pressurized air being contrarotating with respect to the air injected by the swirlers.

2. The injection device as claimed in claim 1, wherein the second venturi and the bowl have total lengths such that the total length of the second venturi represents between 80 and 100% of the total length of the bowl.

3. The injection device as claimed in either one of claims 1 and 2, wherein the divergent part of the second venturi and the flared part of the bowl each have a largest diameter such that the largest diameter of the second venturi represents between 70 and 80% of the largest diameter of the bowl.

4. The injection device as claimed in any one of claims 1 to 3, wherein the first row of orifices in the flared wall of the bowl injects a quantity of pressurized air corresponding to 10 to 20% of the pressurized air injected by the two rows of orifices, and wherein the second row of orifices in the flared wall of the bowl injects a quantity of pressurized air corresponding to 80 to 90% of the pressurized air injected by the two rows of orifices.

5. The injection device as claimed in any one of claims 1 to 4, wherein the ratio V2/V1 is between 2 and 3.

6. A combustion chamber comprising an internal wall, an external wall and a chamber endwall, wherein said combustion chamber is provided with at least one injection device as claimed in any one of the preceding claims.

7. A turbomachine provided with a combustion chamber as claimed in claim 6.
